(19) United States
(12) Patent Application Publication
(10) Pub. No.: US 2009/0250964 A1
(43) Pub. Date: Oct. 8, 2009

(54) MOTOR VEHICLE HAVING A WINDOW PANE HAVING A SUN VISOR AND A COVER

(75) Inventors: Dino DEMMA, Russelsheim (DE); Frank LEOPOLD, Taunusstein-Orlen (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/418,268

(22) Filed: Apr. 3, 2009

(30) Foreign Application Priority Data
Apr. 4, 2008 (DE) 102008017197.2

(51) Int. Cl. B60J 3/00; B60J 3/02; B60J 3/04; H04N 7/18

(52) U.S. Cl. 296/97.2; 296/97.8; 296/97.4; 348/148

(57) ABSTRACT

A motor vehicle is provided that has a window pane, preferably a windshield, which has an upper pane section and a lower pane section. Furthermore, a sun visor for the upper pane section and a cover are provided, which may be moved from a starting position via a first position, in which the cover conceals the upper pane section, into a second position, in which the cover additionally conceals the lower pane section. The sun visor is implemented as light-transparent in a way which attenuates the incident light through the upper pane section.

### CROSS-REFERENCE TO RELATED APPLICATION

This application claims priority to German Patent Application No. 102008017197.2, filed Apr. 4, 2008, which is incorporated herein by reference in its entirety.

### TECHICAL FIELD

The present invention relates to a motor vehicle having a window pane, preferably a windshield, which has an upper pane section and a lower pane section, a sun visor for the upper pane section and a cover being provided, which may be moved from a starting position via a first position, in which the cover conceals the upper pane section, into a second position, in which the cover additionally conceals the lower pane section.

### BACKGROUND

DE 20 2006 011 455 U1 describes a motor vehicle having a windshield. The windshield of the known vehicle may be divided into an upper pane section facing toward the vehicle roof and a lower pane section facing away from the vehicle roof. A sun visor is provided inside the known motor vehicle, which is implemented as light-opaque and is fastened so it is movable on a front section of the roof. If the driver is dazzled by the incident light through the upper pane section, he may pivot the light-opaque sun visor from an non-usage position into a usage position, in which the sun visor conceals the upper pane section, so that the incident light through the upper pane section is completely blocked and the driver is no longer dazzled. Furthermore, a cover is provided inside the motor vehicle, which is situated above the front section of the roof lining in a starting position. The known cover, in the form of an awning extendable from a roll, may be moved manually from the starting position via a first position, in which the cover conceals the upper pane section, into a second position, in which the cover additionally conceals the lower pane section. The driver will move the cover from the starting position into the second position in order to block the incident light through the upper and lower pane sections, so that heating of the vehicle interior may be prevented in a parked vehicle.

The configuration according to the prior art described above has proven itself, but is subject to several disadvantages. If sudden, strong incident light occurs through the upper pane section during travel, the driver is forced to pivot the sun visor from the non-usage position into the usage position as rapidly as possible and manually, so as not to be dazzled. If the sun visor of the known motor vehicle is already in the usage position, the driver is not dazzled by the incident light, but the view of the driver through the windshield is permanently restricted, due to which any existing traffic signs or similar features in proximity to the motor vehicle may no longer be perceived. For example, if the motor vehicle is directly in front of a red traffic light, the driver is forced to bend forward in order to be able to see a change of the traffic signal through the lower pane section. The driver may pivot the sun visor back into its non-usage position to be able to see the traffic light better. However, comfortable handling of the sun visor is thus not ensured.

It is therefore at least one object of the present invention to provide a motor vehicle having a window pane, a sun visor, and a cover, which is to allow comfortable handling of the sun visor and the cover, and improved monitoring of the motor vehicle environment by the driver being ensured. In addition, other objects, desirable features and characteristics will become apparent from the subsequent summary and detailed description, and the appended claims, taken in conjunction with the accompanying drawings and this background.

### SUMMARY

The motor vehicle according to an embodiment of the invention has a window pane, which is preferably a windshield. The window pane in turn has an upper pane section and a lower pane section. A sun visor is provided for the upper pane section, which is to prevent dazzling of the vehicle occupant because of incident light through the upper pane section. Furthermore, a cover is provided, which may be moved from a starting position via a first position, in which the cover conceals the upper pane section, into a second position, in which the cover additionally conceals the lower pane section. The cover, which may be implemented like an awning extendable from a roll, for example, may then be moved into the second position if the motor vehicle is parked, in order to prevent heating of the vehicle interior. The cover may be implemented as partially light-transparent or as light-opaque, for example. According to an embodiment of the invention, the sun visor is implemented as light-transparent in a way which attenuates the incident light through the upper pane section, (i.e., the sun visor does not cause complete blocking of the incident light through the upper pane section).

In that the sun visor is implemented as at least partially light-transparent, the vehicle occupant may perceive the vehicle surroundings both through the lower pane section and also through the sun visor and the upper pane section. Because of the fact that the sun visor is implemented as light-transparent in a way which attenuates the incident light through the upper pane section, however, the vehicle occupant is also prevented from being dazzled because of the incident light through the upper pane section. Even a sun visor situated so it is movable inside the motor vehicle may thus remain permanently in its usage position, without restricting the view of the driver on the one hand and risking dazzling of the driver because of the incident light through the upper pane section on the other hand. The special effect of the invention comprises the combination of sun visor and cover. In the event of excessively strong incident light through the upper pane section, in which the sun visor alone is no longer sufficient to protect the vehicle occupant from dazzling, the cover may be moved from its starting position into the first position. In the first position, the cover thus supports the sun panel in repelling the incident light through the upper pane section. The cover results in a further attenuation or complete blocking of the incident light through the upper pane section in the first position, depending on how the cover is implemented, namely, for example, as light-transparent in a way which attenuates the incident light or as light-opaque. The vehicle occupant or the driver is accordingly first forced to become active if the incident light through the upper pane section is particularly strong, so that in this way greater security for the vehicle occupants. In addition, the vehicle occupant may move the cover into the second position to prevent heating of the vehicle interior if the motor vehicle is parked.

Fundamentally, the configuration according to an embodiment of the invention may be used for any window pane of the motor vehicle. However, because the driver must be protected from dazzling to a special degree as the vehicle controller and must have a good overview of the traffic action, the window pane is a windshield in a preferred embodiment of the motor vehicle according to the invention (i.e., it is the front pane assigned to the driver).

In an especially preferred embodiment of the motor vehicle according to an embodiment of the invention, the cover may be locked in the first position. In this way, the cover may permanently remain in the first position to supplement the sun visor and thus reliably prevent dazzling of the driver and/or vehicle occupant.

In an advantageous embodiment of the motor vehicle according to the invention, the cover is implemented as light-transparent in a way which attenuates the incident light through the upper pane section and possibly the lower pane section or as light-opaque. In the first case, the cover may supplement the sun visor in the first position so that the incident light through the upper pane section is attenuated even more strongly, but is not completely repelled. Furthermore, it is possible for the driver in this case to see outward through the sun visor, the cover, and the upper pane section, to be able to perceive the surroundings of the motor vehicle. In the second case, the incident light through the upper pane section would be completely repelled and/or reflected because of the cover located in the first position. Dazzling of the vehicle occupant because of the incident light through the upper pane section is thus entirely prevented in the second case.

In a further advantageous embodiment of the motor vehicle according to the invention, the cover is situated above a roof lining of a motor vehicle in the starting position, an opening being provided, through which the cover may be moved from the starting position into the first or second position. The opening is preferably implemented as a gap which may be implemented in the roof lining or between the roof lining and an adjoining vehicle part, such as the vehicle roof, for example. Furthermore, the roof lining may be composed of separate modules, the cover being situated above one of the modules and preferably being able to be connected thereto. This has the advantage that this roof lining module may be installed together with the cover in the motor vehicle. Fundamentally, this embodiment has the advantage that the cover is situated in an especially space-saving way inside the motor vehicle, without excessively restricting the freedom of movement of the vehicle occupants.

To provide an especially simple cover, which additionally ensures simple handling, in a further advantageous embodiment of the motor vehicle according to the invention, the cover is implemented as an awning which may be unrolled from a roll, the roll preferably being situated above the roof lining or the previously cited roof lining module.

In a further preferred embodiment of the motor vehicle according to the invention, the light transparency of the sun visor may be changed. The fundamental construction of a light-transparent object whose light transparency may be changed is known, so that the prior art is referred to at this point. The fundamental light-transparent sun visor having changeable light transparency has the decisive advantage in relation to the known light-opaque sun visors that the vehicle occupant does not have to grasp and adjust the sun visor, as is the case for the light-opaque sun visors. It is thus ensured in particular that the vehicle occupant does not have to firstly grasp upward in order to pivot the sun visor in the event of sudden strong incident light through the upper pane section. The risk of accident is thus reduced in such a situation, which is hazardous in any case.

In a further especially preferred embodiment of the motor vehicle according to the invention, a light transparency of the sun visor may be set by the vehicle occupant. The vehicle occupant thus has the capability of setting the light transparency of the sun visor in accordance with his wishes. It is especially advantageous if a corresponding actuating element for setting the light transparency of the sun visor is situated within reach of the vehicle occupant, for example, so that the actuating element may be reached rapidly if there is sudden, strong incident light through the upper pane section. As already indicated previously, the risk of accident may be significantly decreased in this way.

In a further, particularly advantageous embodiment of the motor vehicle according to the invention, the sun visor is implemented in such a way that its light transparency may be changed automatically as a function of the intensity of the solar radiation. Reference may also be made to the prior art in regard to the construction of sun visors implemented in this way. Thus, for example, self-tinting glasses are known, whose light transparency changes automatically as a function of the intensity of the solar radiation. Thus, the sun visor may be formed by a self-tinting glass or plastic pane, for example. In this embodiment, the vehicle occupant is no longer required at all to react rapidly in the event of unexpected strong incident light through the upper pane section. The risk of accident is thus reduced to a minimum in such a hazard situation.

According to a further advantageous embodiment of the motor vehicle according to the invention, the light transparency of the sun visor may be reduced in the event of strong solar radiation and increased in the event of weaker solar radiation. The vehicle occupant, in particular the driver, is thus automatically and reliably protected from strong solar radiation, which dazzles him.

To situate the sun visor in an especially space-saving way, in a further advantageous embodiment of the motor vehicle according to the invention, the sun visor is fastened on the upper pane section or implemented in one piece with the upper pane section. In the second case, the upper pane section thus concurrently forms the sun visor.

According to a further advantageous embodiment of the motor vehicle according to the invention, the sun visor is fastened on the upper pane section in that it is connected, preferably glued to the upper pane section pressing flatly against the upper pane section. The sun visor may thus be implemented as a tinted, tintable, and/or self-tinting film or glass pane which is connected flatly to the upper pane section.

In a further advantageous embodiment of the motor vehicle according to the invention, the upper pane section, which concurrently implements the sun visor, is implemented as a tinted, tintable, and/or self-tinting pane section.

In a further advantageous embodiment of the motor vehicle according to the invention, a rearview mirror is provided, which is situated on the roof lining, preferably on the side of the roof lining facing toward the vehicle interior. The rearview mirror is accordingly not situated on the inside of the window pane, where it would obstruct the movement of the cover from the starting position into the first or second position. The cover thus also does not have to be implemented as slotted to allow a collision-free movement thereof into the first or second position, rather the cover may advantageously be implemented as continuous in the transverse direction to allow the most complete possible concealment of the window pane and to reliably prevent heating of the vehicle interior when the vehicle is parked.

If the roof lining does not extend sufficiently far forward that a reasonable configuration of a rearview mirror on the roof lining is possible, which allows monitoring of the traffic behind, in a further especially preferred embodiment of the motor vehicle according to the invention, a camera for registering the traffic behind and a monitor for displaying the images registered by the camera may be provided. While a typical rearview mirror must always be situated in predetermined areas inside the motor vehicle, for example, on the roof lining or on the windshield, to allow monitoring of the traffic behind, the monitor may be situated relatively arbitrarily inside the motor vehicle according to this embodiment. Thus, for example, a configuration of the monitor in the area of the dashboard would be possible, so that the monitor does not represent an obstruction for the cover when it is moved from the starting position into the first or second position. The monitor may also be formed by the window pane itself, on which the images of the traffic behind are projected.

According to a further preferred embodiment of the motor vehicle according to the invention, the sun visor is situated in the vehicle while implementing a gap between the sun visor and the inside of the upper pane section, the cover being able to be moved through the gap from the starting position into the first or second position. In this embodiment, the sun visor is also situated in such a way that an obstruction-free movement of the cover from the starting position into the first or second position is possible. The gap is to face toward the opening, through which the cover may be moved from the starting position into the first or second position. The situation of the sun visor spaced apart from the inside of the upper pane section may be caused, for example, in that the sun visor is fastened on a motor vehicle part, such as the roof lining or the A-column.

According to a further especially preferred embodiment of the motor vehicle according to the invention, the cover may be supported and/or guided on the side of the sun visor facing toward the gap. The sun visor is thus additionally used, upon the movement of the cover from the starting position into the first or second position, for supporting and/or guiding the cover, so that additional support and/or guide means may be dispensed with in this area. Furthermore, this embodiment is advantageous in particular if the cover is implemented as a flexible awning, because the sun visor may reliably prevent sagging or moving up and down in the event of vertical excitations due to roadway irregularities in this case, in that the cover is supported on the bottom and guided in the movement direction.

According to a further advantageous embodiment of the motor vehicle according to the invention, the sun visor is fastened fixedly (i.e., immovably, on the roof lining). As already previously explained, the fundamentally light-transparent sun visor according to an embodiment of the invention does not have to be pivoted into a non-usage position to allow a view through the upper pane section. Therefore, an especially simple configuration of the sun visor is provided in this embodiment, without any pivot means being necessary for the sun visor. Rather, the sun visor remains fixedly and/or permanently in the usage position.

In a further especially preferred embodiment of the motor vehicle according to an embodiment of the invention, a rearview mirror which is fastened on the sun visor is provided. Thanks to the sun visor, which is spaced apart from the upper pane section while implementing the gap, it is possible in this embodiment to situate the rearview mirror especially far forward, without obstructing the cover during its movement from the starting position into the first or second position. The rearview mirror is preferably fastened on the side of the sun visor facing away from the upper pane section.

Alternatively to the two preceding described embodiments, in a further advantageous embodiment of the motor vehicle according to the invention, the sun visor is fastened on the roof lining so it is movable, preferably pivotable, and may be moved from a usage position, in which the incident light through the upper pane section is attenuated, into a non-usage position. It is thus possible for the vehicle occupant to cancel the protective action of the sun visor entirely, in that he moves it into the non-usage position. In this way, the vehicle occupant has an especially good view through the upper pane section, although further pivot means must be provided for the sun visor for this purpose. In addition, the attachment of a rearview mirror on a sun visor movable in this way is no longer possible and/or advisable. Instead, in this case the rearview mirror is again to be situated on the roof lining, the sun visor then being designed in such a way that a collision may not occur between the sun visor in the non-usage position and the rearview mirror.

In a further preferred embodiment of the motor vehicle according to the invention, the cover may only be moved into the second position if the motor vehicle is stationary, the engine or the ignition is turned off, and/or the central locking is actuated. In this way, the vehicle occupant is prevented from moving the cover from the first position into the second position unintentionally during travel, by which the view through the two pane sections of the window pane would be taken away from the driver.

To make the handling of the cover still more comfortable, in a further especially preferred embodiment of the motor vehicle according to the invention, the cover situated in the second position is automatically moved into the first position if the engine or the ignition is turned on or if the central locking is actuated. The vehicle occupant is thus particularly not forced to manually move the cover situated in the second position back into the first position, before the motor vehicle may drive away.

In a further advantageous embodiment of the motor vehicle according to the invention, a drive unit is provided for moving the cover. Such a drive unit may, for example, comprise a two-part synchronous spindle drive having a spindle and a motor on each vehicle side or a double-spindle drive having only one motor. A further drive unit may comprise a cable pull system, for example. In addition to such a motorized drive, a manually operable emergency drive is preferably also to be provided, which also permits a movement of the cover if the motorized drive has broken down. The drive unit fundamentally has the advantage that the vehicle occupant does not have to reach upward into the cover situated in the motor vehicle. Rather, a corresponding actuating element, such as a button, a switch, etc., may be provided within reach of the vehicle occupant here. The handling of the cover is significantly simplified in this way, especially rapid reaction to strong incident light through the upper pane section additionally being possible.

### BRIEF DESCRIPTION OF THE DRAWINGS

The present invention will hereinafter be described in conjunction with the following drawing figures, wherein like numerals denote like elements, and:

FIG. 1 shows a partial side view of a first embodiment of the motor vehicle according to the invention in a sectional illustration having the cover in the starting position;

FIG. 2 shows the motor vehicle from FIG. 1 having the cover in the first position;

FIG. 3 shows the motor vehicle from FIG. 1 and FIG. 2 having the cover in the second position;

FIG. 4 shows a partial side view of a second embodiment of the motor vehicle according to the invention in a sectional illustration having the cover in the starting position;

FIG. 5 shows the motor vehicle from FIG. 4 having the cover in the first position;

FIG. 6 shows the motor vehicle of FIG. 4 and FIG. 5 having the cover in the second position;

FIG. 7 shows a partial side view of a third embodiment of the motor vehicle according to the invention in a sectional illustration having the sun visor in the usage position;

FIG. 8 shows the motor vehicle from FIG. 7 having the sun visor in the non-usage position; and

FIG. 9 shows a partial side view of a fourth embodiment of the motor vehicle according to the invention in a sectional illustration.

### DETAILED DESCRIPTION

The following detailed description is merely exemplary in nature and is not intended to limit the application and uses. Furthermore, there is no intention to be bound by any theory presented in the preceding background or summary or the following detailed description.

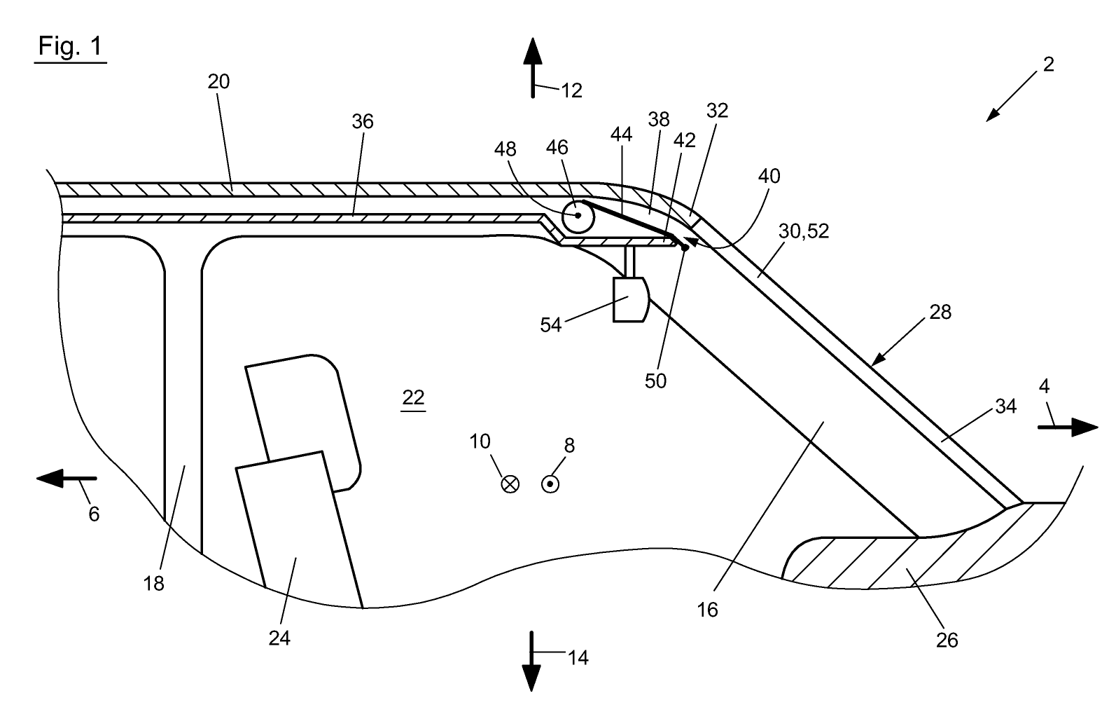

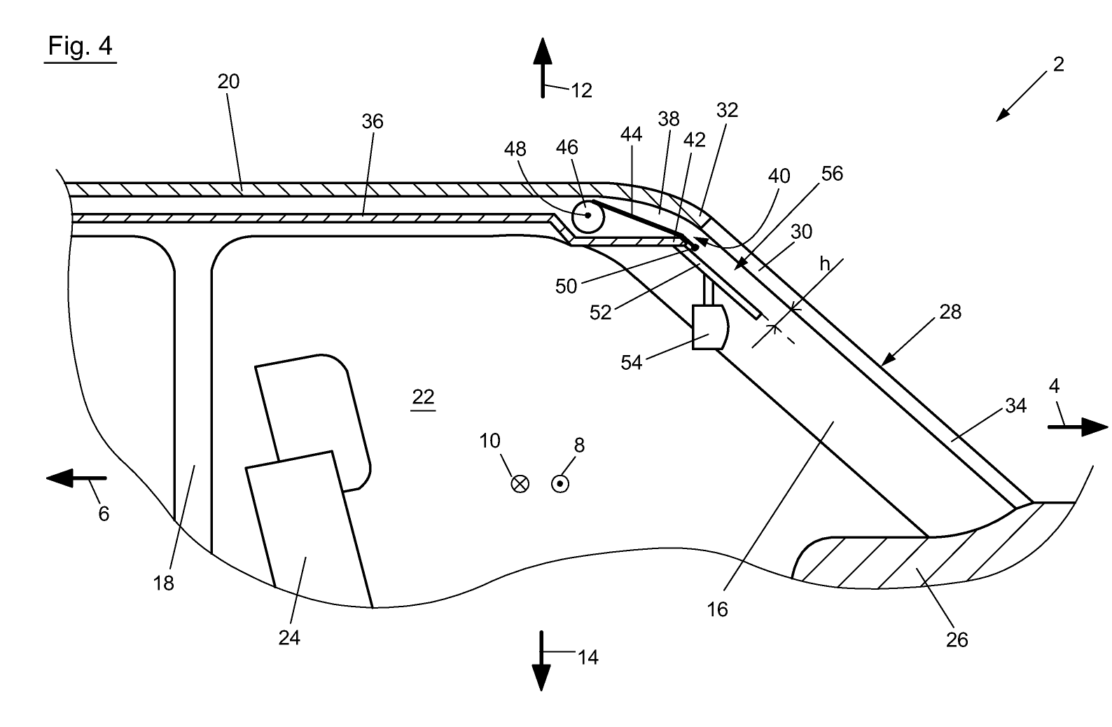

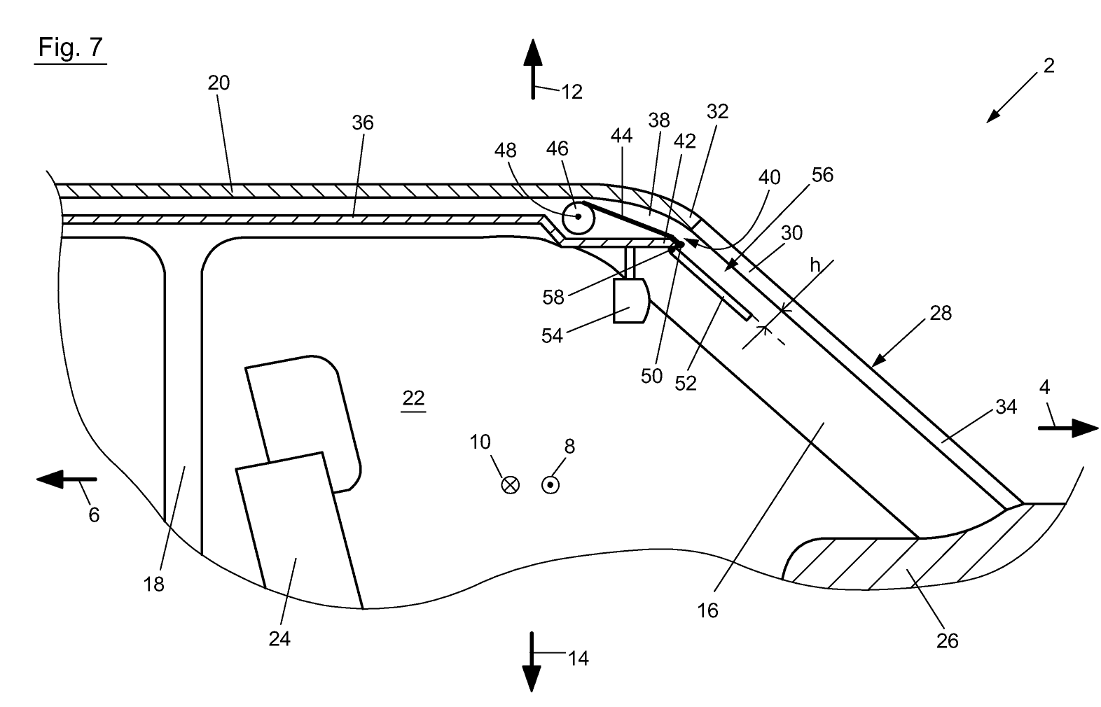

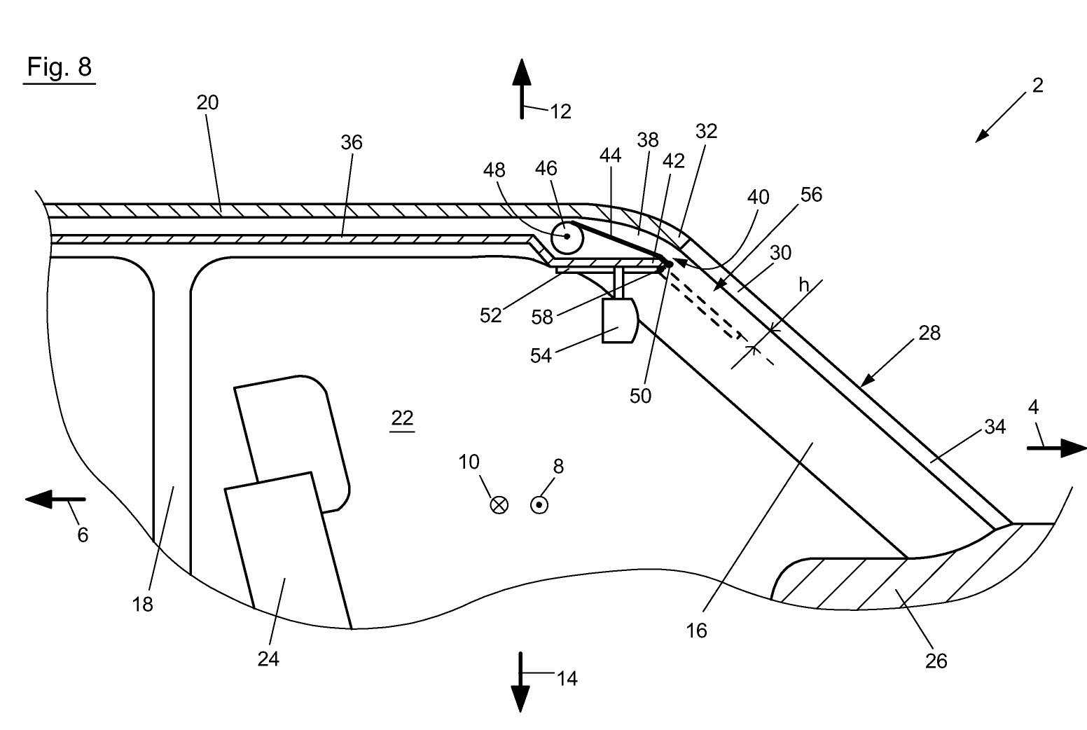

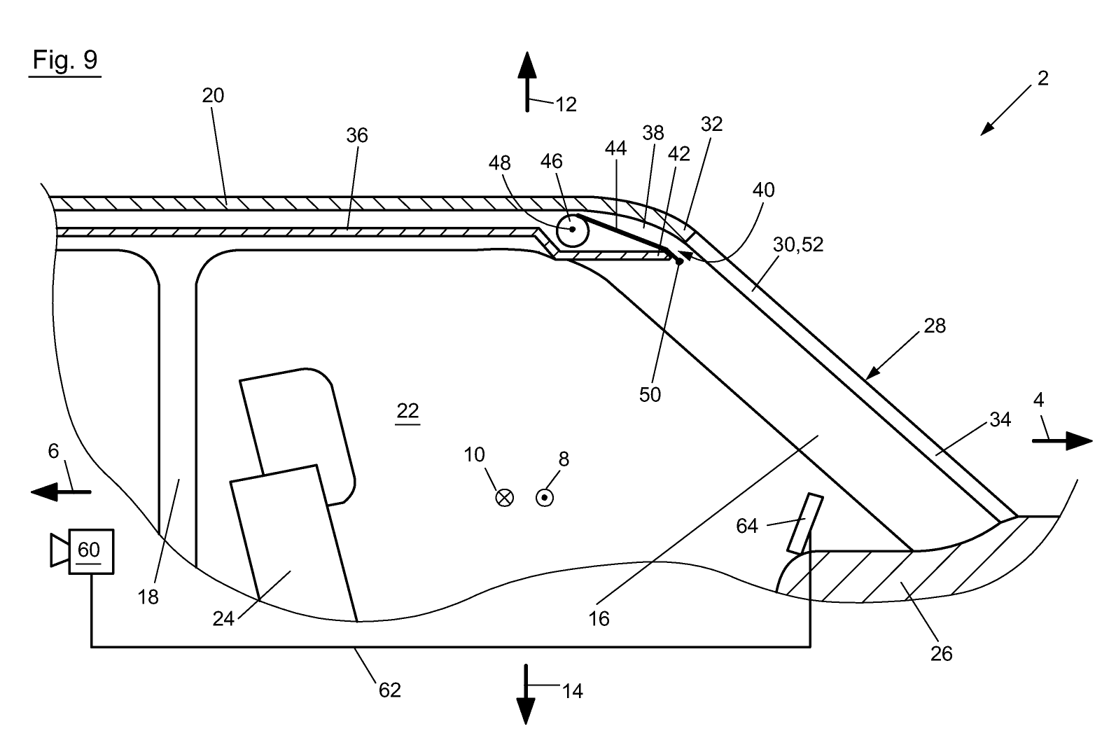

FIG. 1 through FIG. 3, FIG. 4 through FIG. 6, FIG. 7 through FIG. 8, and FIG. 9 each show different embodiments of the motor vehicle 2 according to an embodiment of the invention, the shared features of the motor vehicle 2 firstly being described hereafter.

The forward direction of the motor vehicle 2 is indicated in the figures on the basis of the arrow 4, while the reverse direction is indicated on the basis of the arrow 6. Furthermore, the transverse directions are indicated on the basis of the arrows 8 and 10, while the vertical directions are indicated with the aid of the arrows 12 and 14. The motor vehicle 2 has a vehicle body, which, inter alia, has two A-columns 16 spaced apart from one another in the transverse direction 8 or 10, respectively, and two B-columns 18 spaced apart from one another in the transverse direction 8 or 10, respectively, only one of which may be seen in the figures in each case. The B-column 18 is situated behind the A-column 16 in the reverse direction 6. The vehicle body also has a vehicle roof 20, which delimits the vehicle interior 22 on top in the vertical direction 12. Furthermore, the back rest of a driver seat 24 is shown in the figures, which is situated in a front area of the vehicle interior 22 in front of a dashboard 26.

In the forward direction 4, the vehicle interior 22 is delimited by a window pane which is implemented as a windshield 28. The windshield 28 comprises an upper pane section 30 in the vertical direction 12, which adjoins a front edge 32 of the vehicle roof 20 in the vertical direction 12, and a lower pane section 34 adjoining the upper pane section 30, which is situated below the upper pane section 30 in the vertical direction 14.

Inside the motor vehicle 2, a roof lining 36 is fastened on the side of the vehicle roof 20 facing toward the vehicle interior 22. On the end of the roof lining 36 pointing in the forward direction 4, the roof lining 36 is implemented as trough-shaped in such a way that a receptacle space 38, which is elongate in the transverse direction 8 or 10, is implemented between the inside of the vehicle roof 20 facing toward the roof lining 36 and the inside of the roof lining 36 facing toward the vehicle roof 20. The receptacle space 38 in turn has an opening 40 to the vehicle interior 22, which is implemented as a gap extending in transverse direction 8 or 10. This gap and/or the opening 40 are implemented between the front boundary 42 of the roof lining 36 and the front edge 32 of the vehicle roof 20.

Furthermore, a cover 44 is provided inside the motor vehicle 2 to conceal the upper pane section 30 and possibly the lower pane section 34. In the starting position shown in FIG. 1, FIG. 4, FIG. 7, FIG. 8, and FIG. 9, the cover 44 is situated in the vertical direction 12 above the roof lining 36 and inside the receptacle space 38. In the embodiments according to the invention, the cover 44 is implemented as an awning unrollable from a roll 46, which extends in the transverse directions 8, 10 inside the receptacle space 38 above the roof lining 36 in the vertical direction 12. Accordingly, the rotational axis 48 of the roll 46 runs in the transverse direction 8 or 10. The cover 44 implemented as an unrollable awning is produced from a material which is implemented as either light-transparent in a way which attenuates the incident light through the upper and possibly lower pane sections 30, 34 or as light-opaque.

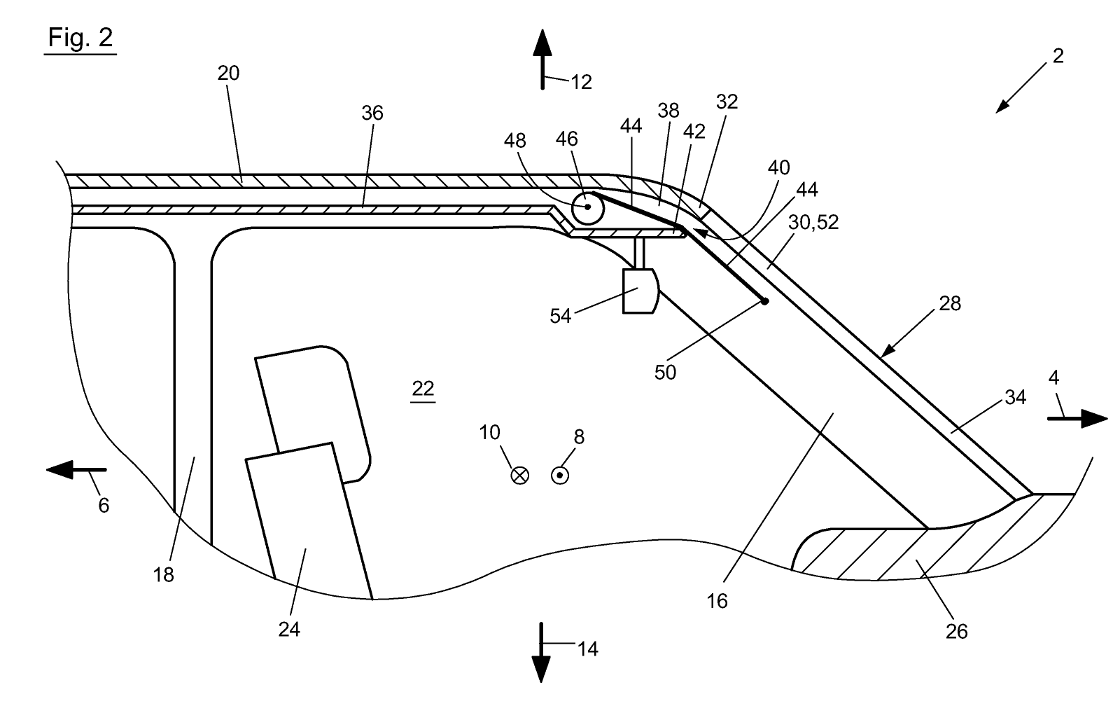

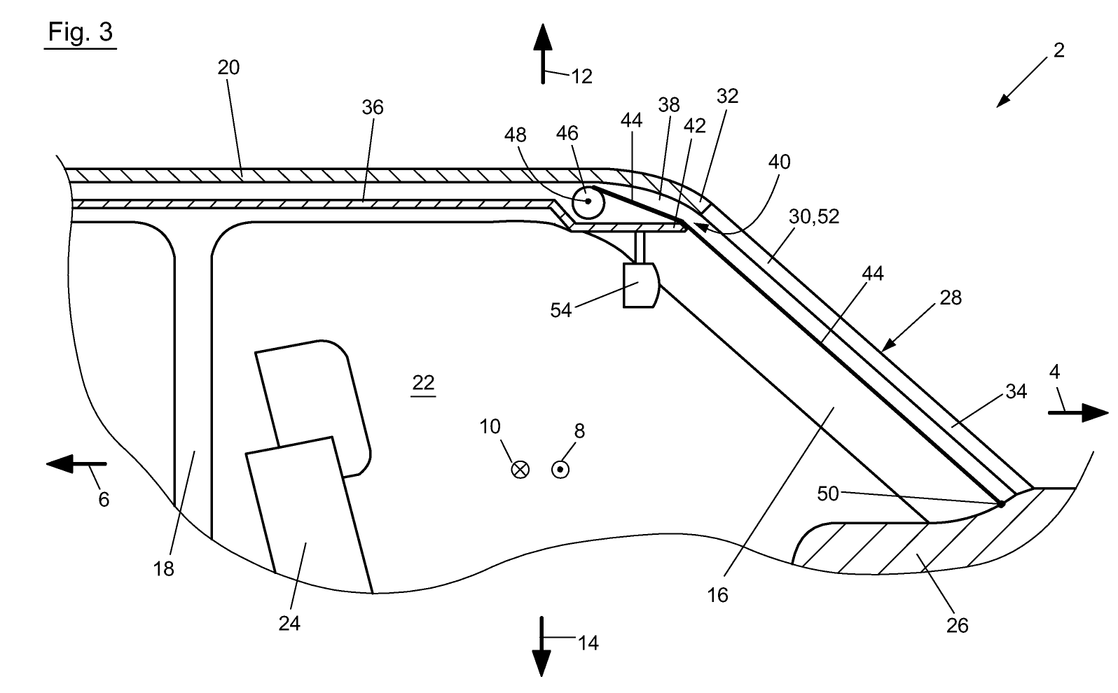

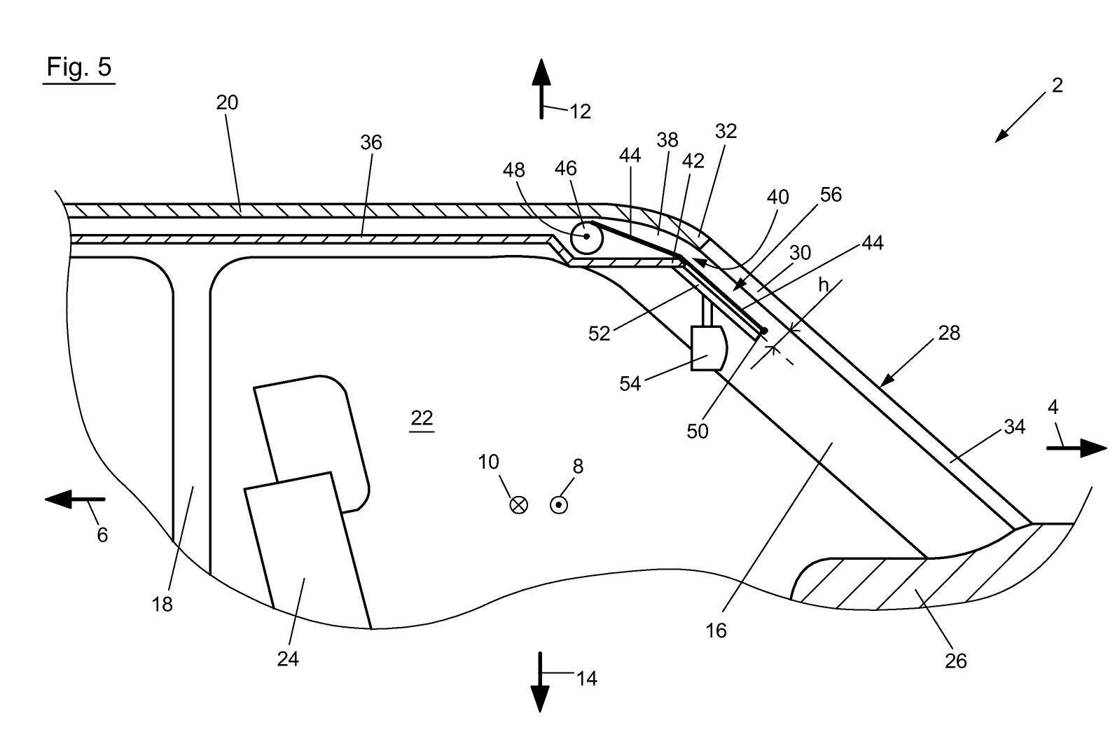

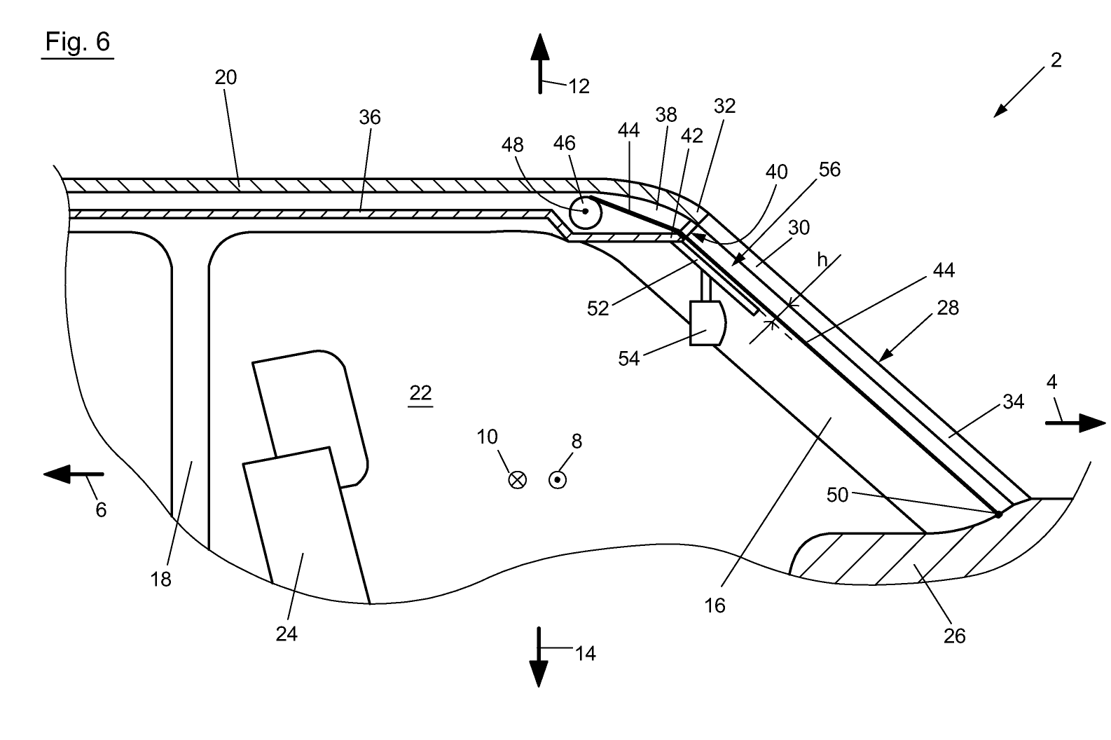

The cover 44 may be extended through the gap-shaped opening 40 from the starting position shown in FIG. 1, FIG. 4, FIG. 7, FIG. 8, and FIG. 9 into a first position shown in FIG. 2 and FIG. 5 by a drive unit (not shown in greater detail) for driving the roll 46. In the first position, the cover 44 conceals the upper pane section of the windshield 28 from the inside, so that the incident light through the upper pane section 30 is attenuated or completely absorbed. The cover 44 is lockable in this first position, which may be caused by turning off the drive unit (not shown). In a further step, the cover 44 may be extended with the aid of the drive unit (not shown) beyond the first position into a second position, which is shown in FIG. 3 and FIG. 6. In this second position, the cover 44 additionally conceals the lower pane section 34 of the windshield 28 from the inside, the extension-side end 50 of the cover 44 adjoining the dashboard 26. In the second position, the incident light through the lower pane section 34 of the windshield 28 is thus also attenuated or completely blocked.

The vehicle occupant will move the cover 44 into the second position if he wants to prevent heating of the vehicle interior 22 because of the incident light through the windshield 28 when the motor vehicle 2 is parked. To prevent the cover 44 from being moved unintentionally from the first position into the second position during travel, a control system (not shown in greater detail) is provided for the drive unit, which is implemented in such a way that the cover 44 may only be moved from the starting position or the first position into the second position if the motor vehicle 2 is stationary, the engine or the ignition of the motor vehicle 2 is turned off, and/or the central locking of the motor vehicle 2 is locked and/or actuated. In addition, the control system works together with the drive unit for the cover 44 in such a way that the cover 44 situated in the second position is automatically moved into the first position if the engine or the ignition of the motor vehicle 2 is turned off or if the central locking of the motor vehicle is actuated (i.e., if the central locking is opened). The handling of the cover 44 is significantly more comfortable in this way.

Furthermore, the embodiments from FIG. 1 through FIG. 9 share the feature that they have at least one sun visor 52 for the upper pane section 30 of the windshield 28. The sun visor 52 is implemented as light-transparent in a way which attenuates the incident light through the upper pane section 30. In the embodiments, however, the light transparency of the sun visor 52 is not fixed at a specific amount, but rather the light transparency of the sun visor 52 may be changed. The light transparency of the sun visor 52 may thus be set by the vehicle occupant via an actuating element (not shown in greater detail) inside the motor vehicle 2. The vehicle occupant may thus set the light transparency of the sun visor 52 in accordance with his wishes. Alternatively or additionally, the light transparency of the sun visor 52 may also be changed automatically as a function of the intensity of the solar radiation. Thus, corresponding sensors may be provided for detecting the intensity of the solar radiation, the light transparency of the sun visor 52 decreasing in the event of stronger solar radiation and being automatically increased in the event of weaker solar radiation. This has the advantage that the driver or the vehicle occupant does not have to act to activate an anti-dazzle device in the event of sudden strong incident light through the upper pane section 30.

Further features of a first embodiment of the motor vehicle 2 are described hereafter with reference to FIG. 1 through FIG. 3. In the first embodiment of the motor vehicle 2 according to the invention, the sun visor 52 is fastened on the upper pane section 30 of the windshield 28 or implemented in one piece with the upper pane section 30 of the windshield 28. In the first alternative, the sun visor 52, which is implemented as a tinted, tintable, and/or self-tinting film or pane, may be connected flatly, preferably glued, to the upper pane section 30 pressing against the upper pane section 30. In a second alternative, in which the sun visor 52 is implemented in one piece with the upper pane section 30, the upper pane section 30 and the sun visor 52 are unified into one part, the upper pane section 30 being able to be implemented in this case as a tinted, tintable, and/or self-tinting pane section. Both alternatives have the advantage that an especially space-saving sun visor 52 may be provided. Furthermore, the sun visor 52 according to the first embodiment of the motor vehicle 2 does not represent an obstruction for the cover 44 when it is moved into the cited positions.

Furthermore, a rearview mirror 54 is provided in the vehicle interior 22. To prevent the cover 44, which is to be extended from the starting position, from colliding with this rearview mirror 54, it is not situated on the inside of the windshield 28, but rather on the side of the roof lining 36 facing toward the vehicle interior 22.

The mode of operation of the cover 44 and the sun visor 52 is described hereafter with reference to FIG. 1 through FIG. 3. During travel, the cover 44 is initially in the starting position shown in FIG. 1. If the solar radiation increases, the light transparency of the sun visor 52 decreases automatically, so that the incident light through the upper pane section 30 decreases and dazzling of the driver is prevented. If the solar radiation increases sufficiently that the sun visor 52 no longer adequately attenuates the incident light through the upper pane section 30, the driver may actuate the drive unit of the roll 46 to move the cover 44 from the starting position (FIG. 1) into the first position shown in FIG. 2. In this first position, the cover 44, together with the sun visor 52, attenuates the incident light through the upper pane section 30 in such a way that even in the event of solar radiation this strong, dazzling of the driver is prevented. If the cover 44 is implemented as light-opaque, dazzling of the driver because of the incident light through the upper pane section 30 is completely prevented. If the driver parks the automobile and turns off the engine or the ignition of the motor vehicle 2, the cover 44 may be moved from the first position (FIG. 1) into the second position shown in FIG. 3 to prevent heating of the vehicle interior 22.

Further features of a second embodiment of the motor vehicle 2 according to the invention are described hereafter with reference to FIG. 4 through FIG. 6. The second embodiment essentially corresponds to the first embodiment from FIG. 1 through FIG. 3, so that only the differences are discussed hereafter and identical reference numerals are used for identical or similar parts, the preceding description applying correspondingly in this regard.

In the second embodiment of the motor vehicle 2 according to the invention, the sun visor 52 is not fastened on the windshield 28 or implemented in one piece with the upper pane section 30. Rather, the sun visor 52 is formed by a separate part, which may be implemented as a tinted, tintable, and/or self-tinting pane, for example. Thus, for example, a plastic pane or a composite safety glass pane comes into consideration as the sun visor 52. The sun visor 52 is fixedly connected to the front boundary 42 of the roof lining 36 (i.e., it is immovably fastened on the roof lining 36 and accordingly forms its extension in the forward direction 4). The sun visor 52 is fastened to the roof lining 36 to implement a gap 56 between the sun visor 52 and the inside of the upper pane section 30. The gap 56 faces toward the gap-shaped opening 40 of the receptacle space 38, in which the cover 44 is situated in the starting position shown in FIG. 4, in the vertical direction 12. The plate-shaped sun visor 52 is adapted to the contour of the upper pane section 30 of the windshield 28 in such a way that the height h of the gap 56 is essentially constant over its entire length. The rearview mirror 54 is not fastened to the roof lining 36 in the second embodiment of the motor vehicle 2, but rather to the side of the sun visor 52 facing away from the upper pane section 30. A configuration of the rearview mirror 54 inside the vehicle interior 22 which is placed further forward in the forward direction 4 is thus possible.

The gap 56 is implemented in such a way that the cover 44 may be moved through it from the starting position of FIG. 4 into the first position of FIG. 5 and the second position in FIG. 6, without being obstructed by the rearview mirror 54. During this movement of the cover 44, the cover 44 is supported on the side of the sun visor 52 facing toward the gap 56 in the vertical direction 14 and guided in the movement direction. Additional support and/or guiding means may thus be dispensed with in this area.

Further features of a third embodiment of the motor vehicle 2 according to the invention are described hereafter with reference to FIG. 7 and FIG. 8. The third embodiment essentially corresponds to the second embodiment from FIG. 4 through FIG. 6, so that only the differences are discussed hereafter, identical reference numerals being used for identical or similar parts and the preceding description applying correspondingly in this regard.

In contrast to the second embodiment, in the third embodiment of the motor vehicle 2 according to the invention, the sun visor 52 is fastened to the roof lining 36 so it is movable and not fixed. For this purpose, the sun visor 52 may be pivoted around a pivot axis 58, running in the transverse direction 8 or 10, from a usage position, which is shown in FIG. 7 and in which the incident light is attenuated by the upper pane section 30, around the pivot axis 58 into a non-usage position, which is shown in FIG. 8. In the non-usage position, the sun visor 52 is pivoted toward the side of the roof lining 36 facing toward the vehicle interior 22, to achieve an especially space-saving configuration. The driver thus has the capability of dispensing with an anti-dazzle device entirely, in that he pivots the sun visor 52 into the non-usage position. However, this has the result that the rearview mirror 54 may not be fastened to the sun visor 52, but rather is again is fastened on the side of the roof lining 36 facing toward the vehicle interior 22. It must also be ensured in this case that the sun visor 52 does not collide with the rearview mirror 54 fastened to the roof lining 36 in the non-usage position shown in FIG. 8. Otherwise, the third embodiment has the same advantages as the second embodiment from FIG. 4 through FIG. 6.

Further features of a fourth embodiment of the motor vehicle 2 according to the invention are described hereafter with reference to FIG. 9. The fourth embodiment essentially corresponds to the first embodiment from FIG. 1 through FIG. 3, so that only the differences are discussed hereafter, identical reference numerals being used for identical or similar parts and the preceding description applying correspondingly in this regard.

In contrast to the first embodiment, in the fourth embodiment of the motor vehicle 2 according to the invention, a conventional rearview mirror 54 is not used. Rather, a camera 60 is provided on the motor vehicle 2 for registering the traffic behind. The camera 60 is connected to a monitor 64 via a line 62, so that the monitor 64 may display the images of the traffic behind, which are registered by the camera 60 and transmitted via the lnposelstartlnpolnposelendselstartlinelnposelend 62. For example, the monitor 64 may be fastened to the dashboard 26, so that the driver has a good view of the monitor 64. This embodiment is especially advantageous if the roof lining 36 and/or its front boundary 42 is not situated far enough in front of the driver seat 24 in the forward direction 4 that a functionally correct attachment of a conventional rearview mirror 54 is possible. In contrast to a conventional rearview mirror 54, the monitor 64 may rather be situated at any point inside the vehicle interior 22 which ensures a good view of the monitor 64. In any case, the monitor 64 must not be situated in an area in which it obstructs the movement of the cover 44 into the previously described positions.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a window pane having an upper pane section and a lower pane section;
a sun visor for the upper pane section that is light transparent and attenuates an incident light through the upper pane section; and
a cover movable from a starting position via a first position, in which the cover is adapted to conceal the upper pane section, into a second position, in which the cover is adapted to conceal the lower pane section.

2. The motor vehicle according to claim 1, wherein the window pane is a windshield.

3. The motor vehicle according to claim 1, wherein the cover is lockable in the first position.

4. The motor vehicle according to claim 1, wherein the cover is light-transparent and attenuates the incident light through the upper pane section and the lower pane section.

5. The motor vehicle according to claim 1, wherein the cover is situated above a roof lining of the motor vehicle in the starting position, and an opening is provided, through which the cover is movable from the starting position into at least one of the first position or the second position.

6. The motor vehicle according to claim 1, wherein the cover is implemented as an awning unrollable from a roll, the roll situated above a lining of a roof.

7. The motor vehicle according to claim 1, wherein a light transparency of the sun visor is changeable.

8. The motor vehicle according to claim 7, wherein the light transparency of the sun visor is settable by an occupant.

9. The motor vehicle according to claim 7, wherein the light transparency of the sun visor is automatically changeable as a function of a solar radiation.

10. The motor vehicle according to claim 9, wherein the light transparency of the sun visor is decreased in an event of a stronger solar radiation and increased in a second event of a weaker solar radiation.

11. The motor vehicle according to claim 1, wherein the sun visor is fastened on the upper pane section.

12. The motor vehicle according to claim 11, wherein the sun visor is connected, to the upper pane section pressing flatly on the upper pane section.

13. The motor vehicle according to claim 11, wherein the upper pane section is implemented as at least one of a tinted, tintable, or self-tinting pane section.

14. The motor vehicle according to claims 11, wherein further comprising a rearview mirror situated on a roof lining.

15. The motor vehicle according to claim 11, further comprising a camera adapted to register rear traffic; and
a monitor adapted to display an images registered by the camera.

16. The motor vehicle according to claim 1, wherein the sun visor is situated between in the motor vehicle with implementation of a gap between the sun visor and the inside of the upper pane section, the cover being movable through the gap from the starting position into the first position and the second position.

17. The motor vehicle according to claim 16, wherein the cover is supported on a side of the sun visor facing toward the gap.

18. The motor vehicle according to one of claims 16, wherein the sun visor is fixedly fastened to a lining of a roof.

19. The motor vehicle according to claim 18, further comprising a rearview mirror fastened on the sun visor.

20. The motor vehicle according to claim 16, wherein the sun visor is fastened on a lining of a roof so it is movable from a usage position, in which the incident light through the upper pane section is attenuated, into a non-usage position.

21. The motor vehicle according to claim 1, wherein the cover is only movable into the second position if at least one of the motor vehicle is stationary, an engine is turned off, or a central locking is actuated.

22. The motor vehicle according to claim 1, wherein the cover situated in the second position is automatically movable into the first position if at least one of an engine is turned on or if a central locking is actuated.

23. The motor vehicle according to claim 1, further comprising a drive unit adapted to move the cover.
